(19) United States
(12) Patent Application Publication
(10) Pub. No.: US 2016/0202710 A1
(43) Pub. Date: Jul. 14, 2016

(54) MOTOR DRIVING CONTROL APPARATUS AND ELECTRICALLY ASSISTED VEHICLE

(71) Applicant: TAIYO YUDEN CO., LTD., Tokyo (JP)

(72) Inventors: Yasuo HOSAKA, Tokyo (JP); Kazuo ASANUMA, Tokyo (JP); Taichi YANAOKA, Tokyo (JP)

(73) Assignee: TAIYO YUDEN CO., LTD., Tokyo (JP)

(21) Appl. No.: 14/912,784

(22) PCT Filed: Aug. 28, 2014
(86) PCT No.: PCT/JP2014/072558

§ 371 Date: Feb. 18, 2016

(30) Foreign Application Priority Data
Aug. 29, 2013 (JP) 2013-177853

(51) Int. Cl. G05D 17/02

(52) U.S. Cl. CPC G05D 17/02

(57) ABSTRACT

A motor driving control apparatus in embodiments has a controller configured to control driving of a motor, and an instruction unit configured to cause the controller to suppress the driving of the motor when detecting a phenomenon that a state in which fluctuation of a pedal input torque is within a predetermined range continues for a period for the predetermined number of pedal rotations or more. The suppression of the driving of the motor may include stop of the driving of the motor, and the pedal input torque may be a value corrected by an offset value. Furthermore, the motor driving control apparatus may be used by an electrically assisted vehicle.

### TECHNICAL FIELD

This invention relates to a motor driving control technique in an electrically assisted vehicle.

### BACKGROUND TECHNOLOGY

In driving control for an electric motor in the electrically assisted bicycle or the like, the driving for the electric motor is controlled in accordance with an object based on signals of a torque sensor, a vehicle speed sensor, a motor current sensor and/or the like. The driving control is performed in various viewpoints such as safety, compliance with laws, assisting feeling and starting response, however, in order to perform appropriate driving control, it is assumed that the sensors always output correct values.

For example, as illustrated in the left side of FIG. 1, an output of a torque sensor typically changes as the pulse of the heart in connection with the driver's pedal rotation operation. However, as illustrated in the right side of FIG. 1, when any failure occurs in the torque sensor, a constant value may be outputted regardless of the driver's pedal rotation operation.

In such a case, when the motor driving is performed according to the output of the torque sensor, the assist is performed contrary to the driver's intention.

Then, according to a certain conventional technique, a countermeasure is performed by a method to stop the motor driving when a state where a fluctuation range of the pedal pressure is narrow continues for a predetermined time or more.

However, in this conventional technique, in order to avoid risks of erroneous determination, “the predetermined time” is set to be long to some extent, based on a case where the pedal rotates at a low speed. This is because it is impossible to distinguish, within a short time, a state where the fluctuation of the pedal pressure is small because the pedal rotates at a low speed from a state where the fluctuation of the pedal pressure is small because of the failure as described above, when the predetermined time is set to be short.

However, when the torque sensor has a fault, it is preferable that any countermeasure is made soon for the failure.

### PRIOR TECHNICAL DOCUMENTS

### Patent Documents

Patent Document 1: Japanese Laid-open Patent Publication No. 8-230751

### SUMMARY OF THE INVENTION

### Object to be Solved by the Invention

As described above, as one aspect, an object of this invention is to provide a technique for coping with the failure of the torque sensor early.

### Means for Solving the Problem

A motor driving control apparatus relating to this invention includes: (A) a controller configured to control driving of a motor; (B) an instruction unit configured to cause the controller to suppress the driving of the motor when detecting a phenomenon that a state where fluctuation of a pedal input torque is within a predetermined range continues for a period for the predetermined number of pedal rotations or more.

By determining, based on the number of pedal rotations instead of a predetermined constant period, whether or not a state in which the fluctuation of the pedal input torque is within the predetermined range continues, it becomes possible to perform an appropriate countermeasure for the failure of the torque sensor soon. For example, if the predetermined number of rotations is “1”, it is possible to determine that the abnormal state occurred when the pedal input torque scarcely varies for one pedal rotation, and also detect the abnormal state in a short time period when the pedal rotates at a high speed. Even when the pedal rotates at a low speed, there is no need to set a large temporal margin as set in the conventional technique . Therefore, it is possible to detect the abnormal state soon.

The suppression of the driving of the motor may include stop of the driving of the motor. In addition, notification to a driver may be performed.

Furthermore, the aforementioned pedal input torque may be a value corrected by an offset value.

A program for causing a microprocessor to execute the aforementioned processing can be created. The program is stored in a computer-readable storage medium or storage device such as a flexible disk, an optical disk like CD-ROM, a magneto-optical disk, a semiconductor memory (e.g. ROM) or harddisk. Data during the processing is temporarily stored in the storage device such as a RAM (Random Access Memory) or the like.

### Effect of the Invention

According to one aspect, it becomes possible to cope with the failure of the torque sensor soon.

### BRIEF DESCRIPTION OF THE DRAWINGS

FIG. 1 is a diagram to explain a problem of a conventional technique;

FIG. 2 is a diagram depicting an exterior view of a bicycle with a motor;

FIG. 3 is a functional block diagram of a motor driving control device;

FIG. 4 is a functional block diagram of a computing unit;

FIG. 5 is a diagram depicting a processing flow of the computing unit;

FIG. 6 is a diagram depicting a processing flow of the computing unit;

FIG. 7 is a diagram schematically illustrating operations relating to this embodiment; and

FIG. 8 is a functional block diagram of the computing unit when it is implemented by a microprocessor.

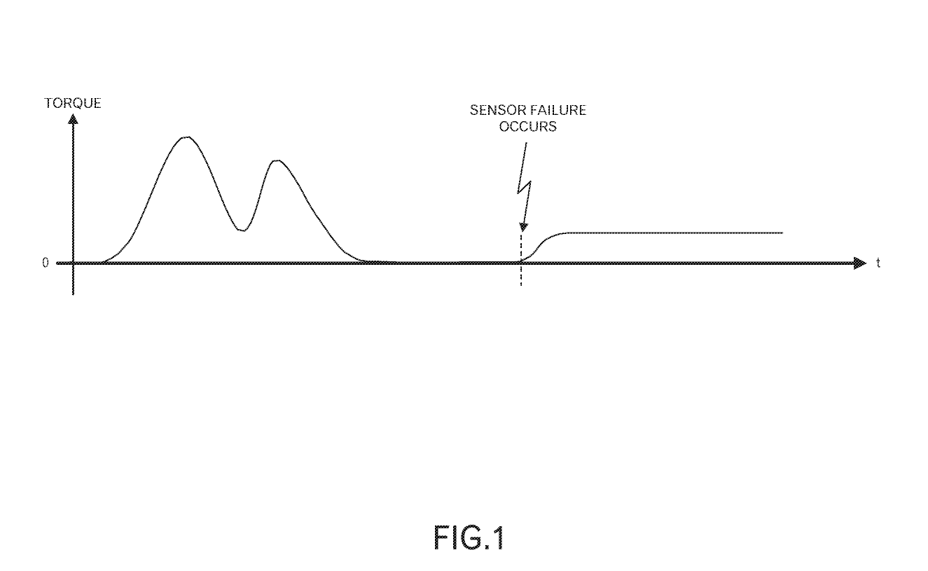

### MODE FOR CARRYING OUT THE INVENTION

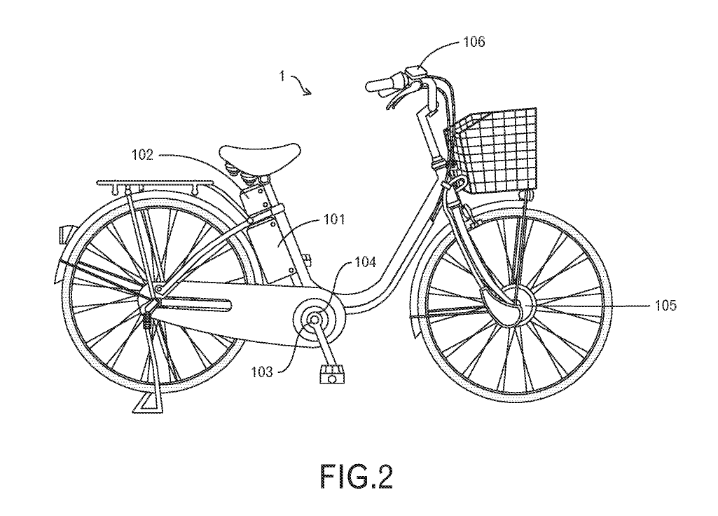

FIG. 2 illustrates an exterior view depicting an example of a bicycle with a motor, which is an electrically assisted vehicle in this embodiment. A motor driving apparatus is equipped on this bicycle 1 with the motor. The motor driving apparatus has a secondary battery 101, a motor driving control device 102, a torque sensor 103, a pedal rotation sensor 104, a motor 105 and an operation panel 106.

The secondary battery 101 may be, for example, a lithium ion secondary battery whose maximum voltage (a voltage when it is fully charged) is 24V, but other types of batteries such as a lithium ion polymer secondary battery, or a nickel-metal hydride chargeable battery may be used.

The torque sensor 103 is provided on a wheel, which is installed in the crankshaft, detects a pedal pressure from the rider, and outputs this detection result to the motor driving control device 102. Similarly to the torque sensor 103, the pedal rotation sensor 104 is provided in the wheel, which is installed on the crankshaft, and outputs a signal, which corresponds to the rotation, to the motor driving control device 102.

The motor 105 is, for example, a well-known three-phase direct current brushless motor, and mounted on the front wheel of the bicycle 1 with the motor. The motor 105 rotates the front wheel, and also a rotor is connected to the front wheel so as to rotate according to the rotation of the front wheel. Furthermore, the motor 105 is equipped with a rotation sensor such as a hall effect sensor to output rotation information of the rotor (i.e. a hall signal) to the motor driving control device 102.

The operation panel 106 receives an instruction input regarding presence or absence of the assist, for example, from the user and outputs the instruction input to the motor driving control device 102. Moreover, the operation panel 106 outputs a signal representing a transmission gear ratio (also called “gear ratio”) of the transmission to the motor driving control device 102.

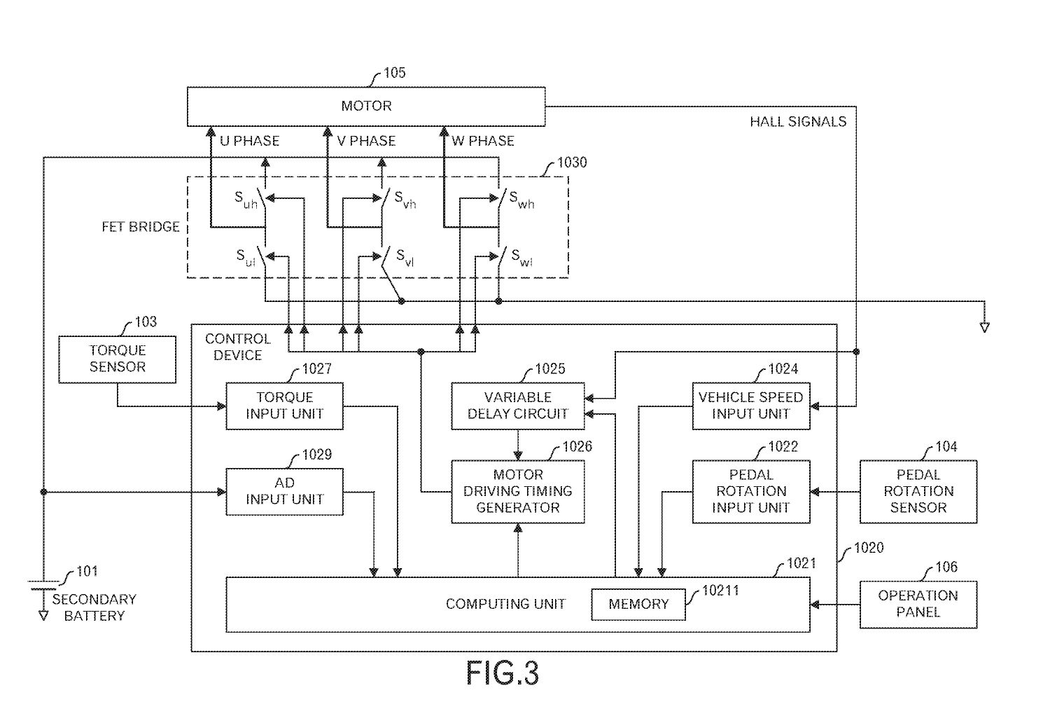

FIG. 3 illustrates a configuration related to the motor driving control device 102 of this kind of the bicycle 1 with the motor. The motor driving control device 102 includes a control device 1020, and a FET (Field Effect Transistor) bridge 1030. The FET bridge 1030 includes a high side FET (Sᵤₕ) and a low side FET (Sᵤ₁) to perform switching of a U phase of the motor 105, a high side FET (Sᵥₕ) and a low side FET (Sᵥ₁) to perform switching of a V phase of the motor 105, and a high side FET (S_{wh}) and a low side FET (S_{w1}) to perform switching of a W phase of the motor 105. This FET bridge 1030 is configured as a portion of the complementary type switching amplifier.

In addition, the control device 1020 includes a computing unit 1021, a pedal rotation input unit 1022, a vehicle speed input unit 1024, a variable delay circuit 1025, a motor driving timing generator 1026, a torque input unit 1027 and an AD input unit 1029.

The computing unit 1021 performs computations described later using input from the operation panel 106 (i.e. the gear ratio, on/off of the assist), input from the vehicle speed input unit 1024, input from the pedal rotation input unit 1022, input from the torque input unit 1027, and input from the AD input unit 1029. After that, the computing unit 1021 outputs computation results to each of the motor drive timing generator 1026 and the variable delay circuit 1025. The computing unit 1021 includes a memory 10211, and the memory 10211 stores various data used in the computing, data currently in processing, and other data. Further, the computing unit 1021 may be realized by executing a program with a processor, and in this case, the program may be recorded in the memory 10211.

The vehicle speed input unit 1024 calculates the current vehicle speed (also called a motor-driven wheel speed) from the hall signals outputted by the motor 105, and outputs the current vehicle speed to the computing unit 1021. The pedal rotation input unit 1022 digitizes signals representing the pedal rotation phase angle and the like from the pedal rotation sensor 104, and outputs the digitized signals to the computing unit 1021. The torque input unit 1027 digitizes signals corresponding to the pedal pressure from the torque sensor 103, and outputs the digitized signals to the computing unit 1021. The AD (Analog-Digital) input unit 1029 digitizes an output voltage from the secondary battery 101, and outputs the digitized output voltage to the computing unit 1021. Moreover, the memory 10211 may be provided separately from the computing unit 1021.

The computing unit 1021 outputs an advance value as the computing result to the variable delay circuit 1025. The variable delay circuit 1025 adjusts the phases of the hall signals based on the advance value received from the computing unit 1021, and outputs the adjusted hall signals to the motor driving timing generator 1026. The computing unit 1021 outputs, as the computing result, a PWM (Pulse Width Modulation) code corresponding to the PWM duty ratio, for example, to the motor driving timing generator 1026. The motor driving timing generator 1026 generates switching signals and outputs these to respective FETs included in the FET bridge 1030, based on the adjusted hall signals from the variable delay circuit 1025 and the PWM code from the computing unit 1021.

The basic operation of the motor driving is described in the International Publication WO2012/086459, and is not a main portion of this embodiment. Therefore, the explanation is omitted here.

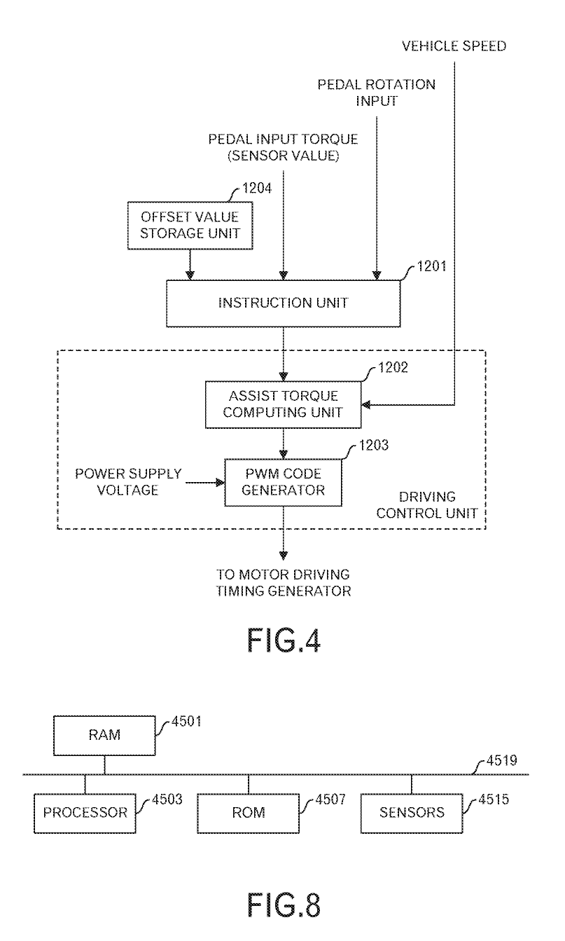

Next, FIG. 4 illustrates a functional block diagram of the computing unit 1021 that performs a main processing relating to this embodiment. The computing unit 1021 has an offset value storage unit 1204, an instruction unit 1201, an assist torque computing unit 1202 and a PWM code generator 1203. The assist torque computing unit 1202 and the PWM code generator 1203 operate as a driving control unit for the motor.

The instruction unit 1201 performs a processing to determine whether or not a phenomenon that represents an abnormal state such as a failure of the torque sensor 103 occurred, based on the pedal rotation input (e.g. phase angle or the number of rotations) from the pedal rotation input unit 1022, the pedal input torque (here, sensor value) from the torque input unit 1027 and an offset value for correction of the pedal input torque, which is stored in the offset value storage unit 1204. When the instruction unit 1201 determines that the phenomenon that represents the abnormal state occurred, the instruction unit 1201 outputs a suppression instruction for causing to suppress the motor driving or a stop instruction for causing to stop the motor driving to the assist torque computing unit 1202, and when the instruction unit 1201 determines that the phenomenon that represents the abnormal state does not occur, the instruction unit 1201 outputs the pedal input torque corrected by the offset value (hereinafter, referred to “a corrected pedal input torque”) to the assist torque computing unit 1202. Instead of the suppression instruction or the stop instruction, the corrected pedal input torque =“zero” may be outputted.

The assist torque computing unit 1202 performs predetermined computation based on the corrected pedal input torque (which may be zero) from the instruction unit 1201 and the vehicle speed from the vehicle speed input unit 1024. Next, the assist torque computing unit 1202 outputs a duty code relating to a duty ratio for the PWM (Pulse Width Modulation) to the PWM code generator 1203. The computation of this assist torque computing unit 1202 is computation described in detail in WO2012/086458, for example. When simply describing the computation, the pedal input torque is converted to a first duty code that corresponds to the duty ratio according to a predetermined rule. The vehicle speed is converted to a second duty code that corresponds to the duty ratio according to a predetermined rule. By adding these first and second duty codes, the assist torque computing unit 1202 calculates a duty code to be outputted to the PWM code generator 1203.

As described above, in response to the stop instruction or suppression instruction from the instruction unit 1201, the assist torque computing unit 1202 outputs an instruction for causing to stop or suppress the motor driving to the PWM code generator 1203. When the PWM code generator 1203 receives the instruction for causing to stop or suppress the motor driving from the assist torque computing unit 1202, the PWM code generator 1203 outputs a signal to stop or suppress the motor driving to the motor driving timing generator 1026 or the like. The assist torque computing unit 1202 may output the stop instruction for causing to stop the motor driving or the suppression instruction for causing to suppress the motor driving directly.

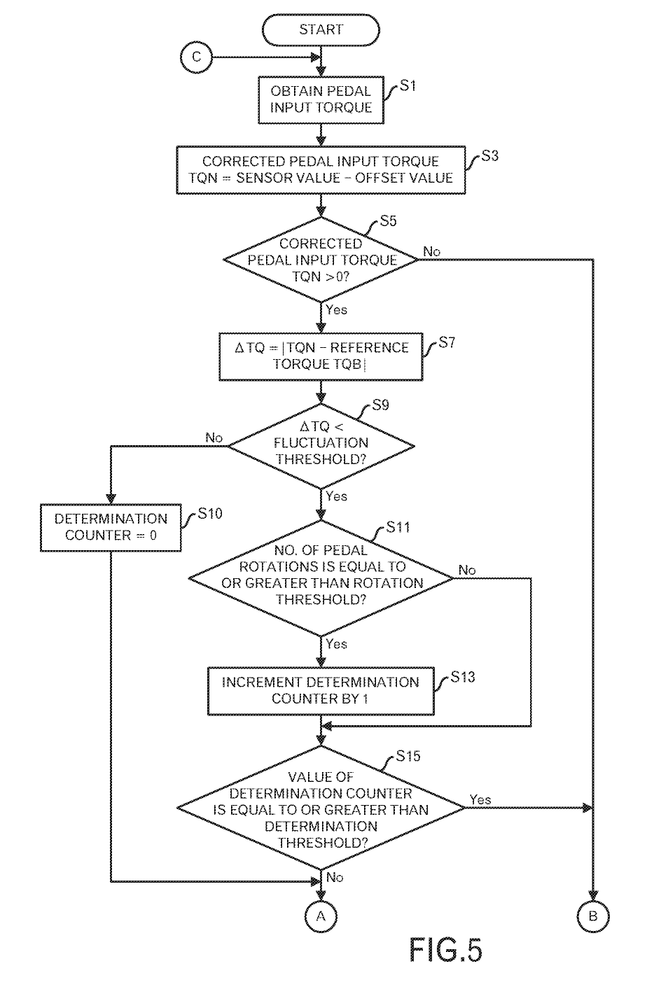

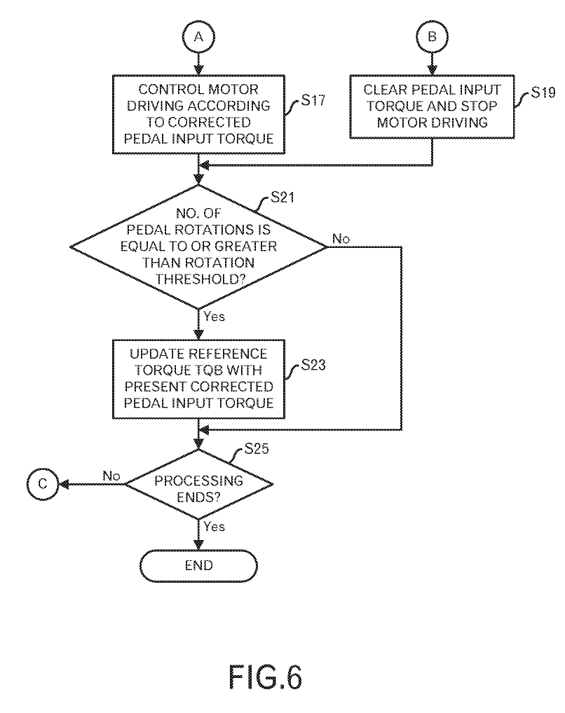

Next, processing contents by the computing unit 1021 relating to this embodiment will be explained by using FIGS. 5 and 6.

In this embodiment, it is assumed that an execution interval of the steps S1 to S25 by the computing unit 1021 is much shorter than a time interval of the measurement by the torque sensor 103.

Firstly, the instruction unit 1201 obtains a pedal input torque (sensor value) from the torque input unit 1027 (step S1). Then, the instruction unit 1201 calculates the corrected pedal input torque TQN by subtracting the offset value stored in the offset value storage unit 1204 from the sensor value (step S3).

After that, the instruction unit 1201 determines whether or not the corrected pedal input torque TQN exceeds “0” (step S5) . When the corrected pedal input torque TQN is equal to or less than “0”, the processing shifts to a processing in FIG. 6 through a terminal B.

On the other hand, when the corrected pedal input torque TQN exceeds “0”, the instruction unit 1201 calculates fluctuation ΔTQ of the torque by |TQN−a reference torque TQB| (step S7). Initially, the reference torque TQB is set to be “0” or the like . In addition, although it will be explained later, for example, when the number of pedal rotations becomes equal to or greater than a rotation threshold, the reference torque TQB is updated by the corrected pedal input torque at that timing.

Then, the instruction unit 1201 determines whether or not the fluctuation ΔTQ of the torque is less than a fluctuation threshold (step S9). The fluctuation threshold is determined, for example, as a predetermined ratio (e.g. 10%) of the reference torque TQB|. However, the fluctuation threshold may be a fixed value.

When the fluctuation threshold ΔTQ of the torque is equal to or greater than the fluctuation threshold, the instruction unit 1201 initializes a determination counter of the failure to “0” (step S10). Then, the processing shifts to a processing in FIG. 6 through a terminal A.

On the other hand, when the fluctuation ΔTQ of the torque is less than the fluctuation threshold, the instruction unit 1201 determines whether or not the number of pedal rotations (phase angle) obtained from the pedal rotation input unit 1022 is equal to or greater than a rotation threshold (step S11). For example, as the rotation threshold, 0.2 pedal rotation is used. The maximum pedal frequency in the range in which the torque is inputted is about 120 rpm, typically, and 0.2 pedal rotation corresponds to 100 ms. On the other hand, typically, an operation interval of the steps S1 to S25 is equal to or less than 10 ms, therefore, even when the pedal rotation is fast, it is possible to appropriately detect the change of the number of pedal rotations when the number of pedal rotations is almost equal to the aforementioned rotation threshold.

Therefore, when the number of pedal rotations is less than the rotation threshold, the processing shifts to step S15. On the other hand, when the number of pedal rotations is equal to or greater than the rotation threshold, the instruction unit 1201 increments the value of the determination counter by “1” (step S13).

Then, the instruction unit 1201 determines whether or not the value of the determination counter is equal to or greater than a determination threshold (step S15). For example, when the purpose is to detect one rotation, the determination threshold is “5”. When the value of the determination counter is equal to or greater than the determination threshold, the processing shifts to the processing of FIG. 6 through terminal B. On the other hand, when the value of the determination counter is less than the determination threshold, the processing shifts to the processing of FIG. 6 through the terminal A.

Shifting to explanation of the processing of FIG. 6, after the terminal B, the instruction unit 1201 clears the corrected pedal input torque to zero, and outputs zero to the assist torque computing unit 1202, or outputs an instruction to stop or suppress the motor driving to the assist torque computing unit 1202 and the like (step S19). When the pedal input torque is cleared to zero and zero is outputted to the assist torque computing unit 1202, the assist torque computing unit 1202 performs predetermined computation based on, for example, a vehicle speed as assuming zero as the pedal input torque, and outputs a duty code relating to a duty ratio of the PWM to the PWM code generator 1203. In addition, the PWM code generator 1203 generates a PWM code by multiplying the battery voltage from the AD input unit 1029/reference voltage (e.g. 24V) to the duty code, and outputs the PWM code to the motor driving timing generator 1026. Thus, the motor driving is controlled.

When the motor driving is suppressed, the corrected pedal input torque of a very small value is outputted to the assist torque computing unit 1202. The corrected pedal input torque of a negative value may be outputted in order to suppress the motor driving for the vehicle speed. Then, the processing shifts to step S21. Furthermore, as described above, the motor driving may be stopped or suppressed forcibly.

On the other hand, after the terminal A, the instruction unit 1201 outputs the corrected pedal input torque to the assist torque computing unit 1202. Then, the assist torque computing unit 1202 performs the predetermined computation based on the corrected pedal input torque from the instruction unit 1201, the vehicle speed and the like, and outputs a duty code relating to the duty ratio of the PWM to the PWM code generator 1203. In addition, the PWM code generator 1203 generates a PWM code by multiplying the battery voltage from the AD input unit 1029/reference voltage (e.g. 24V) to the duty code, and outputs the generated PWM code to the motor driving timing generator 1026. Thus, the motor driving is controlled (step S17).

Then, the instruction unit 1201 determines whether or not the number of pedal rotations, which is obtained from the pedal rotation input unit 1022, is equal to or greater than a rotation threshold (step S21) . For example, this rotation threshold is the same as the rotation threshold at the step S11 or may be different. When the number of pedal rotations is less than the rotation threshold, the processing shifts to step S25. On the other hand, when the number of pedal rotations is equal to or greater than the rotation threshold, the instruction unit 1201 updates the reference torque TQB with the current corrected pedal input torque (step S23). Then, the processing shifts to the step S25.

Then, the instruction unit 1201 determines whether or not the processing end is instructed (step S25). When the processing end is not instructed, the processing returns to the step S1 through terminal C. On the other hand, when the processing end is instructed, the processing ends.

By doing so, it is possible to detect a phenomenon that a state in which the fluctuation of the pedal input torque is within a predetermined width continues for a period for the predetermined number of pedal rotations or more, and furthermore, for such a phenomenon, it is also possible to stop or suppress the motor driving.

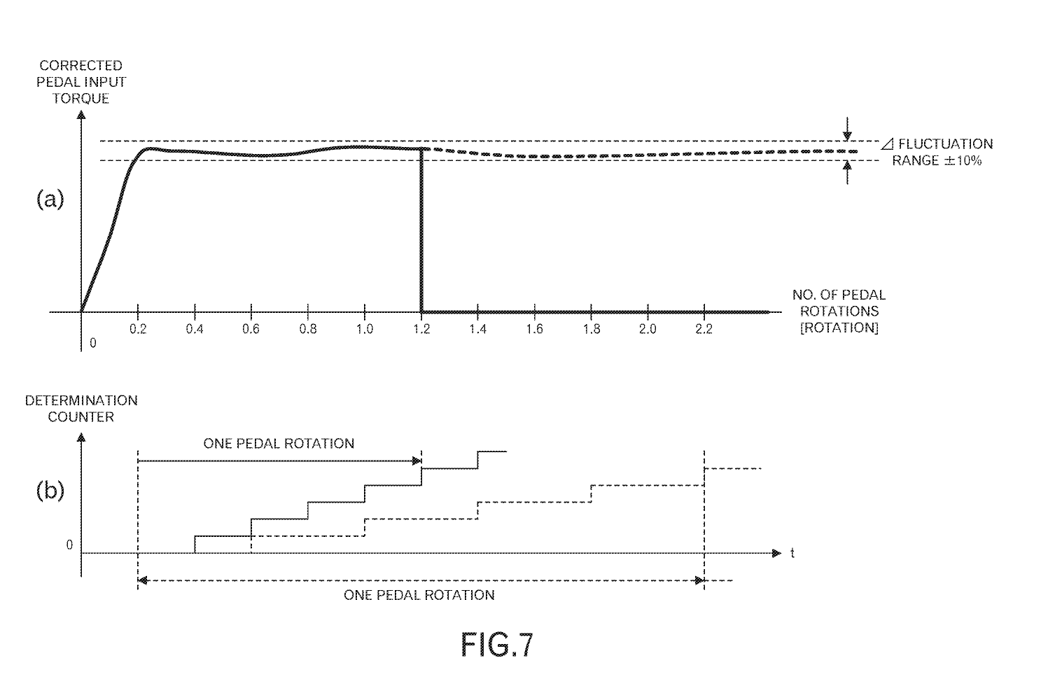

An example of operations that follows such processing flows will be explained by using FIG. 7. (a) of FIG. 7 illustrates an example of temporal changes of the corrected pedal input torque and (b) of FIG. 7 illustrates an example of temporal changes of the count value of the determination counter.

As illustrated in (a) of FIG. 7, when a period for about ⅕ rotation elapsed, because of the failure or the like of the torque sensor 103, a state is obtained that the fluctuation range of the corrected pedal input torque is within +/−10% of the reference torque TQB, which is set as a threshold.

In such a case, as illustrated in (b) of FIG. 7, the determination counter is counted up by one at timings of 0.4 pedal rotation, 0.6 pedal rotation, 0.8 pedal rotation, 1.0 pedal rotation and 1.2 pedal rotation. Then, at the timing of the 1.2 pedal rotation, the value of the determination counter becomes “5”, which corresponds to a period for one pedal rotation since the corrected pedal input torque scarcely changes. Here, as schematically illustrated in (a) of FIG. 7, the corrected pedal input torque is controlled to be zero, for example. However, as described above, the motor driving may be stopped or suppressed.

When the pedal rotation is much slower, as schematically illustrated in (b) of FIG. 7, the counting speed of the determination counter is slow. Therefore, the control operation for causing the corrected pedal input torque to be zero or causing the motor driving to be stopped or suppressed also becomes slow.

Although the embodiments of this invention were explained above, this invention is not limited to those. For example, when a phase angle of the pedal rotation, which is obtained from the pedal rotation input unit 1022, is accumulated at predetermined intervals and then an accumulated phase angle that corresponds to the predetermined number of rotations is obtained without using the determination counter, the motor driving may be stopped or suppressed.

Furthermore, as for the processing of FIGS. 5 and 6, when a failure of the torque sensor 103 occurred once, it is assumed that the outputted pedal input torque becomes almost constant. However, in case where this assumption does not hold, for example, when the value of the determination counter initially becomes equal to or greater than the determination threshold at the step S15, a flag may be set, and for example, it may be determined, before the step S9, whether or not the flag has been set, and when the flag has been set, the processing may not shift to the step S10.

In addition, portions or all of the motor driving control device 102 may be implemented by dedicated circuits or the aforementioned functions may be implemented by executing, by a microprocessor, programs.

Furthermore, in the above explanation as one example, the assist torque computing unit 1202 performs control according to the vehicle speed, however, the calculation of the assist torque may be performed without using the vehicle speed.

In such a case, as illustrated in FIG. 8, in the motor driving control device 102, a RAM (Random Access Memory) 4501, a processor 4503, a ROM (Read Only Memory) 4507 and sensors 4515 are connected with a bus 4519. Programs to perform a processing in this embodiment and an Operation System (OS) if it exists are stored in the ROM 4507, and when the processor 4503 executes them, they are read out from the ROM 4507 and loaded to the RAM 4501. The ROM 4507 records thresholds and other parameters, and these parameters are also read out. The processor 4503 controls the aforementioned sensors 4515 and obtains measurement values. In addition, data during the processing is stored in the RAM 4501. The processor 4503 may include the ROM 4507, and may further include the RAM 4501. In this embodiment, the control program to perform the aforementioned processing may be stored in the computer-readable removable disk and distributed, and may be written in the ROM 4507 by a ROM writer . Such a computer device realizes the aforementioned functions by systematically cooperating hardware such as the aforementioned processor 4503, RAM 4501, ROM 4507 and the like with programs (OS if necessary).

### DESCRIPTION OF SYMBOLS

1201 instruction unit
1202 assist torque computing unit
1203 PWM code generator
1204 offset value storage unit

1. A motor driving control apparatus, comprising:
a controller configured to control driving of a motor; and
an instruction unit configured to cause the controller to suppress the driving of the motor when detecting a phenomenon that a state in which fluctuation of a pedal input torque is within a predetermined range continues for a period for a predetermined number of pedal rotations or more.

2. The motor driving control apparatus as set forth in claim 1, wherein the suppression of the driving of the motor includes stop of the driving of the motor.

3. The motor driving control apparatus as set forth in claim 1 or 2, wherein the pedal input torque is a value corrected by an offset value.

4. An electrically assisted vehicle, comprising:
a motor; and
a motor driving control apparatus, comprising:
a controller configured to control driving of the motor; and
an instruction unit configured to cause the controller to suppress the driving of the motor when detecting a phenomenon that a state in which fluctuation of a pedal input torque is within a predetermined range continues for a period for a predetermined number of pedal rotations or more.
